(19) United States
(12) Patent Application Publication
(10) Pub. No.: US 2004/0019830 A1
(43) Pub. Date: Jan. 29, 2004

(54) Test apparatus of semiconductor integrated circuit with hold error preventing function

(75) Inventors: Shiro Hosotani, Tokyo (JP); Susumu Hirano, Tokyo (JP)

Correspondence Address: BURNS, DOANE, SWECKER & MATHIS, L.L.P., P.O. Box 1404, Alexandria, VA, 22313-1404, US

(73) Assignee: Mitsubishi Denki Kabushiki Kaisha.

(21) Appl. No.: 10/349,998

(22) Filed: Jan. 24, 2003

(30) Foreign Application Priority Data
Jul. 25, 2002 (JP) 2002-217013

(51) Int. Cl. H02H 3/05

(52) U.S. Cl. 714/30

(57) ABSTRACT

A test apparatus has a scan path consisting of scan flip-flops connected in a shift register fashion. Any two adjacent scan flip-flops include clock generating circuits for generating clock signals for shifting scan data at a rising edge and a falling edge of the clock signals in a test scan mode, respectively. Each clock generating circuit further includes a scan flag generator for generating a scan flag for halting the clock signal of the scan flip-flop. The test apparatus can prevent a hold error due to clock skew without complicating the design process, and with a simple circuit configuration.

### BACKGROUND OF THE INVENTION

1. Field of the Invention

The present invention relates to a test apparatus of a semiconductor integrated circuit for carrying out a scan test using the shift operation of adjacent scan flip-flops on a scan path.

2. Description of Related Art

FIG. 20 is a circuit diagram showing a configuration of an ordinary conventional test apparatus of a semiconductor integrated circuit described in DFT (Diagnostic Function Test) Compiler Summary or Principles of CMOS VLSI Design.

In FIG. 20, reference numerals 1A and 1B each designate a combinational circuit to be tested, and 20 each designate a scan flip-flop (called SFF from now on). Among these SFFs, the SFF0-SFF3 are connected to the input side of the combinational circuit 1A, SFF4-SFF7 are connected between the combinational circuits 1A and 1B, and the SFF8-SFF11 are connected to the output side of the combinational circuit 1B. A scan path P is formed through the SFF0-SFF11 connected to the input and output sides of the combinational circuits 1A and 1B. In FIG. 20, the reference symbol A designates a data input terminal for a non-test mode, Y designates a data output terminal for the non-test mode, SI designates a scan data input terminal, SO designates a scan data output terminal and SM designates a scan mode setting terminal.

FIG. 21 shows a symbol of one of the SFFs (SFF0-SFF11) of the test apparatus as shown in FIG. 20, and FIG. 22 shows a configuration of the SFF.

As shown in FIG. 22, the SFF comprises a selector 22 controlled in accordance with the state of its scan mode setting terminal SM, and a flip-flop (called “FF” from now on) 23 supplied with the output of the selector and the clock signal CLK. When the scan mode setting terminal SM=“1”, the selector 22 supplies the input terminal D of the FF 23 with the scan data input to the scan data input terminal SI.

Next, the operation of the conventional test apparatus will be described with reference to the time chart of FIG. 23.

First, the scan mode is established by placing the scan mode setting terminal at SM=1, followed by the shift-in operation of input scan data D0-D7 from the scan data input terminal SI in response to the clock signal CLK. Subsequently, the run operation is carried out by placing SM=0 and by inputting the clock pulse for only one-clock cycle. In the run operation, since the scan path P is set at a non-test path via the scan mode setting terminal SM, the output scan data Q0-Q7 processed by the combinational circuits 1A and 1B are supplied to the SFF4-SFF11. In FIG. 23, the symbol X designates don't care data, and symbols SFF0_Q-SFF11_Q designate the output terminals of the SFF0-SFF11.

Subsequently, the shift-out operation is carried out by setting the selector 22 at the scan path P side by placing the scan mode setting terminal at SM=1 again, in order to check whether the combinational circuits 1A and 1B performs a desired operation. Thus the scan test is carried out through the three steps: shift-in operation, run operation and shift-out operation.

With the foregoing configuration, the conventional test apparatus of a semiconductor integrated circuit carries out data transfer via the path SFF0→SFF1→SFF2→ . . . in the shift-in and shift-out operations. Since these scan flip-flops are connected directly without any circuit between them, they are apt to cause a hold error owing to clock skew. To prevent the hold error, the following protective measures are conceivable.

(a) Inserting a hold error protective buffer between each adjacent SFFS.

(b) Reducing the clock skew as small as possible. However, these protective measures have problems of increasing the number of undesired gates or complicating the design. In particular, the problem will grow larger as the gate delay becomes smaller with the development of microfabrication technique.

### SUMMARY OF THE INVENTION

The present invention is implemented to solve the foregoing problem. It is therefore an object of the present invention to provide a test apparatus of a semiconductor integrated circuit capable of preventing the hold error caused by the clock skew using a simple circuit configuration.

According to one aspect of the present invention, there is provided a test apparatus of a semiconductor integrated circuit, in which any two adjacent scan flip-flops on a scan path carry out the shift-in operation and shift-out operation of scan data in synchronism with different clock edges, that is, a rising edge and a falling edge, respectively. Thus, the test apparatus can prevent the hold error, obviate the need for inserting buffers into the scan path as a hold error protective measures, and maintain the number of gates necessary for the scan test within a fixed number. Consequently, it offers an advantage of being able to limit an increase in the number of gates for the scan test, and to prevent the design process from becoming complicated.

### BRIEF DESCRIPTION OF THE DRAWINGS

FIG. 1 is a block diagram showing a configuration of an embodiment 1 of the test apparatus of a semiconductor integrated circuit in accordance with the present invention;

FIG. 2 is a block diagram showing a configuration of an SFF of the embodiment 1;

FIGS. 3A and 3B are block diagrams each showing a configuration of a clock generating circuit of the embodiment 1;

FIG. 4 is a diagram showing a symbol of the SFF of the embodiment 1;

FIG. 5 is a time chart illustrating the operation of the embodiment 1;

FIG. 6 is a circuit diagram showing a configuration of a generator of the embodiment 1;

FIGS. 7A and 7B are time charts each illustrating the operation of the generator of FIG. 6;

FIG. 8 is a block diagram showing a configuration of an embodiment 2 of the test apparatus of a semiconductor integrated circuit in accordance with the present invention;

FIG. 9 is a block diagram showing a configuration of an embodiment 3 of the test apparatus of a semiconductor integrated circuit in accordance with the present invention;

FIG. 10 is a circuit diagram showing a configuration of a generator of an embodiment 4 in accordance with the present invention;

FIG. 11 is a circuit diagram showing a configuration of a generator of an embodiment 5 in accordance with the present invention;

FIG. 12 is a circuit diagram showing a configuration of a clock generating circuit of an embodiment 6 in accordance with the present invention;

FIG. 13 is a block diagram showing a configuration of an embodiment 7 of the test apparatus of a semiconductor integrated circuit in accordance with the present invention;

FIGS. 14A and 14B are circuit diagrams each showing a configuration of an SFF 20 of the embodiment 7;

FIG. 15 is a time chart illustrating the operation of the scan test operation of the embodiment 7;

FIG. 16 is a block diagram showing a configuration of an embodiment 8 of the test apparatus of a semiconductor integrated circuit in accordance with the present invention;

FIG. 17 is a circuit diagram showing a configuration of an SFF of the embodiment 8;

FIG. 18 is a circuit diagram showing a configuration of an SFF of an embodiment 9 in accordance with the present invention;

FIG. 19 is a circuit diagram showing a configuration of an SFF of an embodiment 10 in accordance with the present invention;

FIG. 20 is a block diagram showing a configuration of a conventional test apparatus of a semiconductor integrated circuit;

FIG. 21 shows a symbol of a conventional SFF;

FIG. 22 is a circuit diagram showing a configuration of the conventional SFF; and

FIG. 23 is a time chart illustrating the operation of the conventional test apparatus of a semiconductor integrated circuit.

### DETAILED DESCRIPTION OF THE PREFERRED EMBODIMENTS

The invention will now be described with reference to the accompanying drawings.

Embodiment 1

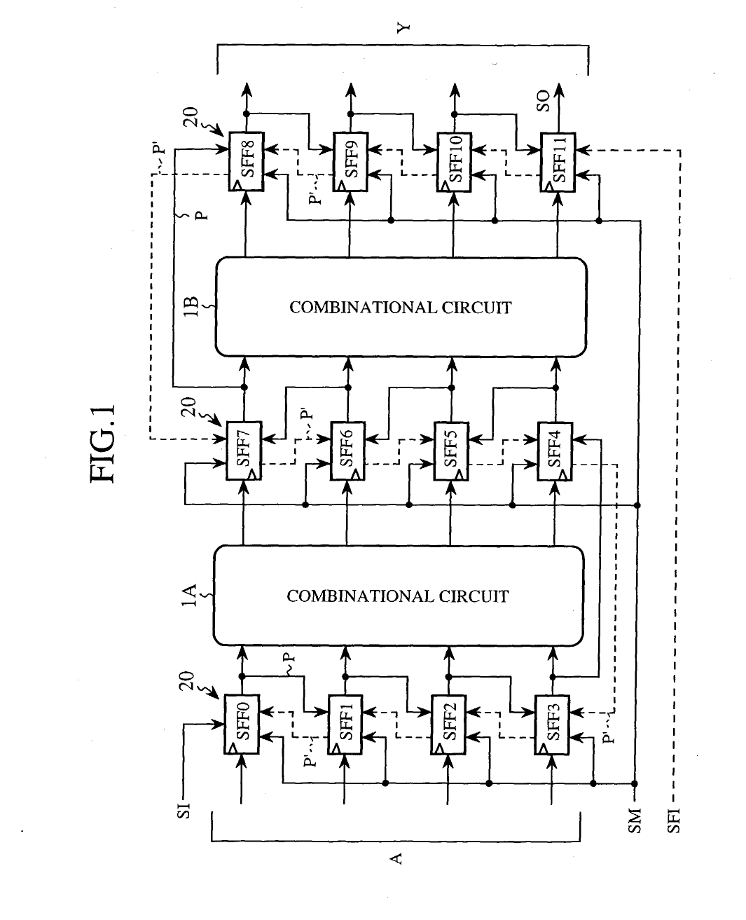

FIG. 1 is a block diagram showing a configuration of an embodiment 1 of the test apparatus of a semiconductor integrated circuit in accordance with the present invention. In FIG. 1, reference numerals 1A and 1B each designate a combinational circuit to be tested, and 20 each designate a scan flip-flop (called SFF from now on). Among these SFFs, the SFF0-SFF3 are connected to the input side of the combinational circuit 1A, SFF4-SFF7 are connected between the combinational circuits 1A and 1B, and the SFF8-SFF11 are connected to the output side of the combinational circuit 1B. A scan path P is formed through the SFF0-SFF11 connected to the input and output sides of the combinational circuits 1A and 1B. In FIG. 1, the reference symbol A designates a data input terminal for a non-test mode, Y designates a data output terminal for the non-test mode, SI designates a scan data input terminal, SO designates a scan data output terminal, SM designates a scan mode setting terminal and P′ designates a scan flag transmission path.

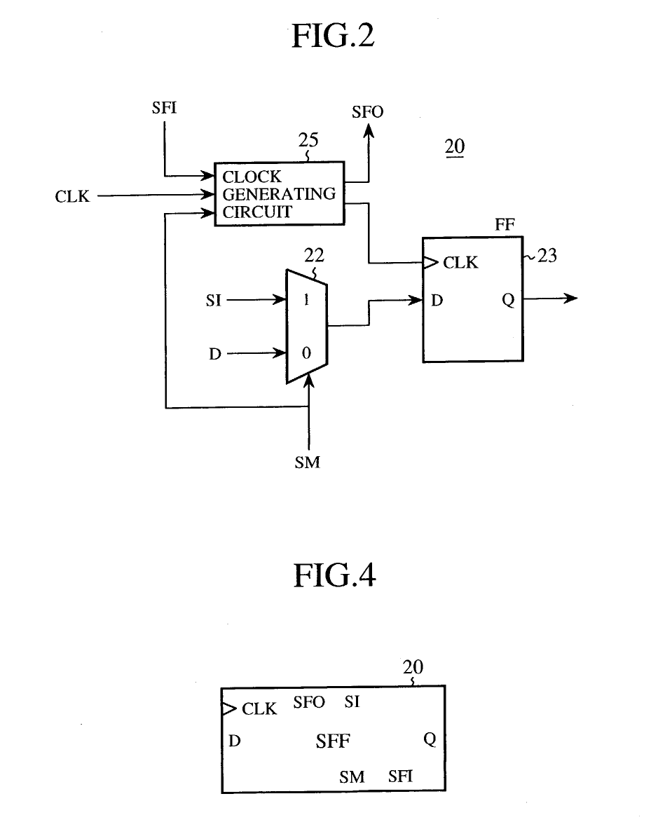

FIG. 2 is a circuit diagram showing a configuration of the SFF 20 (SFF0-SFF11) of the embodiment 1. As shown in FIG. 2, the SFF 20 of the embodiment 1 comprises a clock generating circuit 25 in addition to the conventional SFF as shown in FIG. 22, which includes the selector 22 controlled in accordance with the state of its scan mode setting terminal SM, and the flip-flop (called “FF” from now on) 23 supplied with the output of the selector and the clock signal CLK. In FIG. 2, the reference symbol CLK designates a clock input terminal, D designates a data input terminal, Q designates a data output terminal and SFI designates an input terminal.

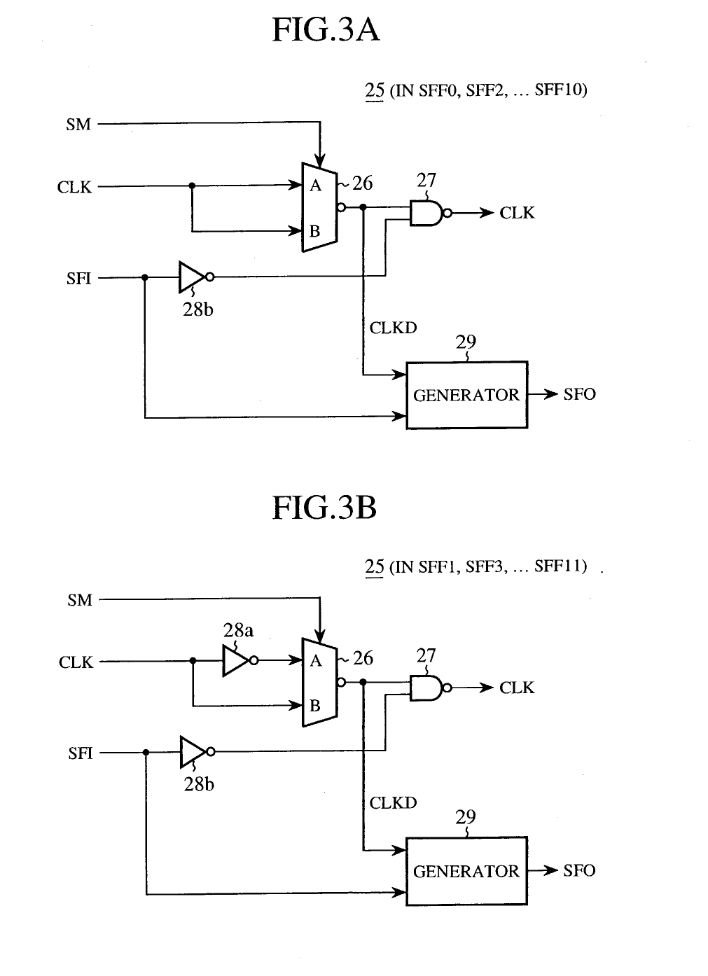

FIGS. 3A and 3B are circuit diagrams each showing a configuration of the clock generating circuit 25. In these figures, the reference numeral 26 designates a selector, 27 designates a NAND circuit, reference numerals 28a and 28b each designates an inverter and the reference numeral 29 designates a scan flag transmission generator. The clock generating circuit 25 has different configurations for even-numbered SFFs, SFF0, SFF2, . . . and SFF10, and for odd-numbered SFFs, SFF1, SFF3, . . . and SFF11, on the scan path of FIG. 1: FIG. 3A shows the even-numbered clock generating circuit 25(Even); and FIG. 3B shows the odd-numbered clock generating circuit 25(Odd).

The clock generating circuit 25 of the odd-numbered SFFs, that is, SFF1, SFF3 . . . and SFF11 in FIG. 1, is configured as shown in FIG. 3B. It supplies the FF 23 of FIG. 2 with an inverted clock when the scan mode setting terminal SM=1. In addition, when the scan flag input signal SFI is “1”, it halts the clock signal CLK, and asserts by the generator 29 the output signal SFO of the generator 29 by the next clock edge. In contrast with this, the clock generating circuit 25 of the even-numbered SFFs, that is, SFF0, SFF2 . . . and SFF10 in FIG. 1, is configured as shown in FIG. 3A. It maintains its clock signal CLK at a fixed polarity regardless of the logic level of the scan mode setting terminal SM. As the odd-numbered clock generating circuit 25, the even-numbered clock generating circuit 25 asserts the output signal SFO of the generator 29 by the next clock edge when the scan flag input signal SFI is asserted.

Although the even-numbered clock generating circuit 25 in FIG. 3A has the selector 26, the selector 26 and its scan mode setting terminal SM can be removed because the polarity of the clock signal CLK is fixed regardless of the logic level of the scan mode setting terminal SM. In this case, the clock signal CLK is connected directly to the input of the NAND circuit 27.

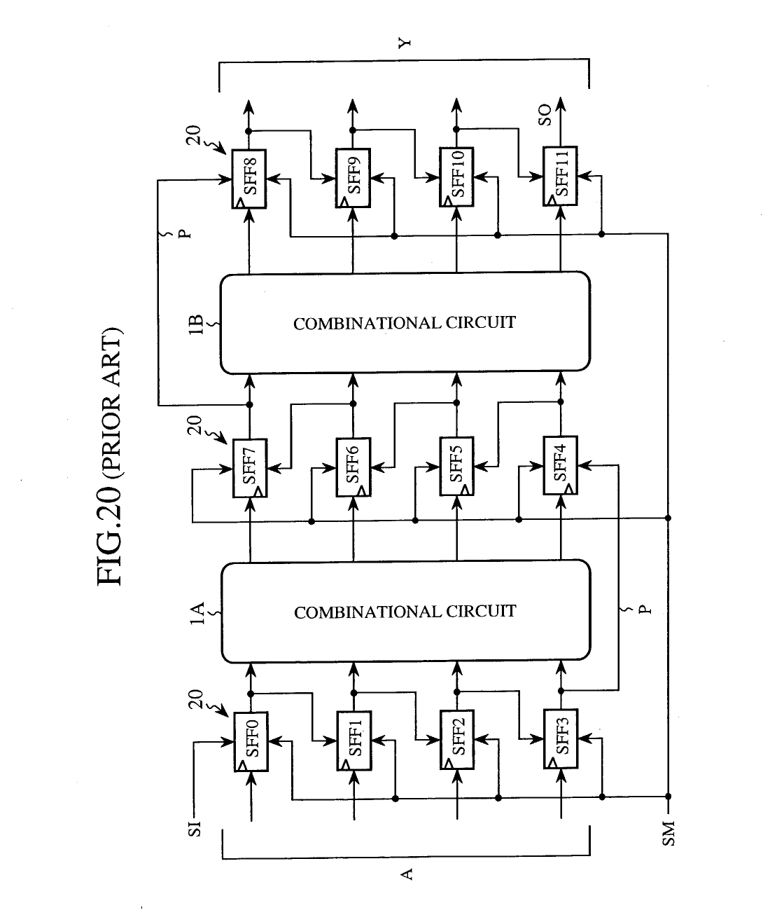

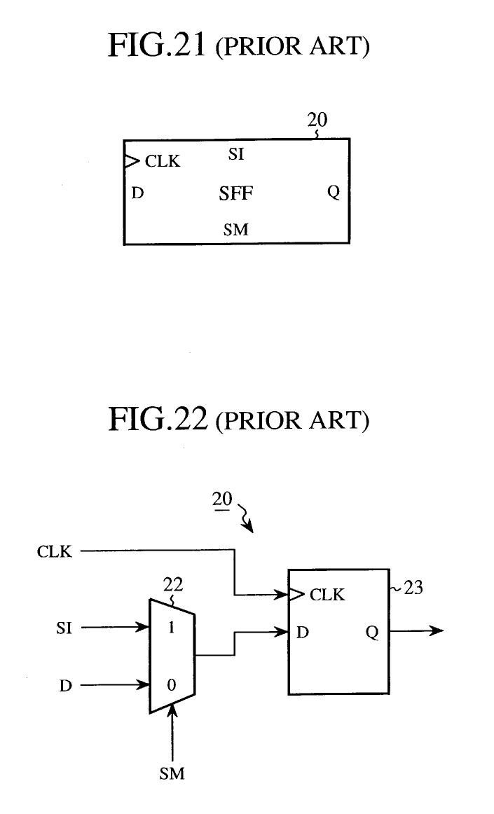

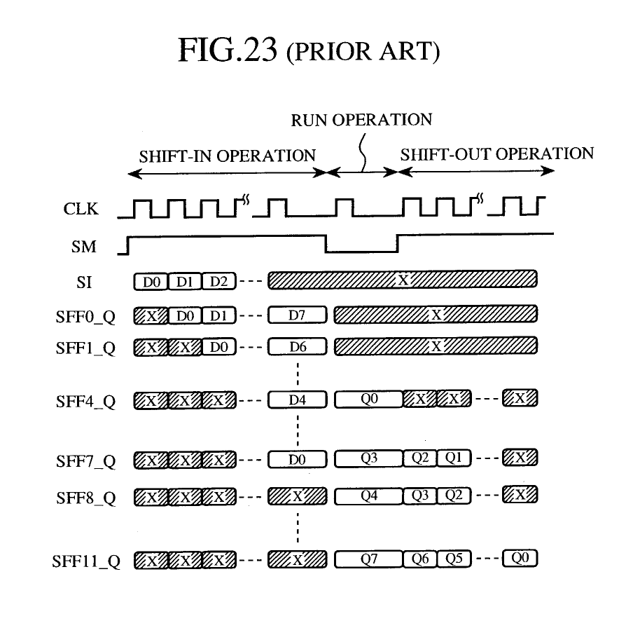

As shown in FIG. 1, the scan test circuit of the embodiment 1 differs from the conventional test circuit of FIG. 20 in that it includes an additional transmission path P′ of the scan flag input signal SFI, which is denoted by broken lines. FIG. 4 shows a symbol of the SFFs of the embodiment 1.

Next, the operation of the present embodiment 1 will be described.

FIG. 5 is a time chart illustrating the operation of the embodiment 1 of the test apparatus of a semiconductor integrated circuit. The odd-numbered SFFs (SSF1, SSF3, . . . and SSF11) differ from the even-numbered SFFs (SFF0, SSF2, and SSF10) in that their FFs 23 operate on the different clock edges during the scan test. The FFs 23 of the even-numbered SFFs operate at the rising (positive) edge of the clock signal CLK. In contrast, the FFs 23 of the odd-numbered SFFs operate at the falling (negative) edge of the clock signal CLK. Thus, the scan data D0, . . . D7 input via the SI terminals are shifted on the scan path P at every half the clock cycle.

The scan flag input signal SFI from the outside is supplied to the SFF11, the final SFF on the scan path. Although it is normally “0”, the scan flag input signal SFI=“1” is supplied from the outside at the exact timing when the first scan data D0 arrives at the SFF7. Thus, the SFF7 halts its clock signal CLK to hold the data D0. The next clock edge asserts the scan flag output signal SFO of the SFF7, which becomes the scan flag input signal SFI to the SFF6. Receiving it, the SFF6 halts its clock signal CLK to hold the data D1. The next clock edge asserts the scan flag output signal SFO of the SFF6, which becomes the scan flag input signal SFI to the SFF5. In response to it, the SFF5 halts its clock signal CLK to hold the data D2. In this way, the scan flag input signal SFI transfer through the path P′, thereby causing the SFF7-SFF0 to hold the data D0-D7 simultaneously.

Once the data D0-D7 have been stored in the SFFs, the scan mode setting terminal is made SM=0 to carry out the run operation in one clock cycle. Then, the scan mode setting terminal is made SM=1 again to proceed to the shift-out operation. The shift-out operation is the same as that of the conventional circuit except that the shift-out is completed in half the clock cycle.

Although the FFs 23 of the even-numbered SFFs operate at the rising (positive) edge of the clock signal CLK, and the FFs 23 of the odd-numbered SFFs operate at the falling (negative) edge of the clock signal CLK in the above, this can be reversed. Thus, the FFs 23 of the even-numbered SFFs can operate at the falling (negative) edge of the clock signal CLK, whereas the FFs 23 of the odd-numbered SFFs can operate at the rising (positive) edge of the clock signal CLK.

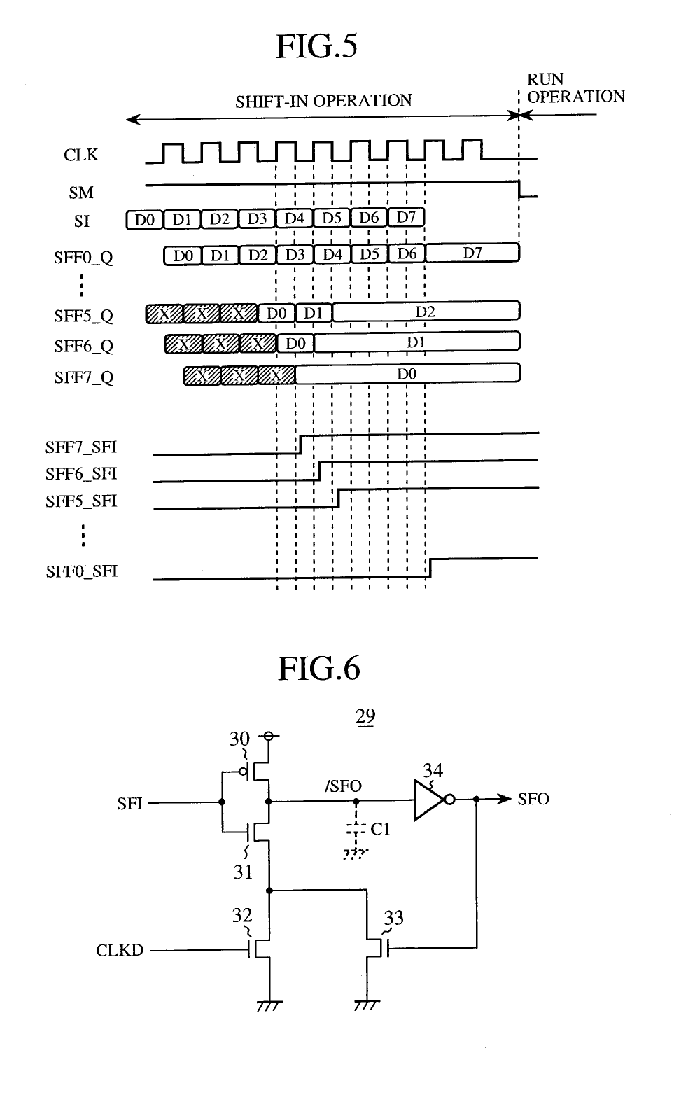

FIG. 6 is a circuit diagram showing a configuration of the generator 29 for causing the scan flag transmission. In FIG. 6, the reference numeral 30 designates a PMOS-FET (abbreviated to PMOS from now on), and reference numerals 31, 32 and 33 each designate an NMOS-FET (abbreviated to NMOS from now on), and the reference numeral 34 designates an inverter.

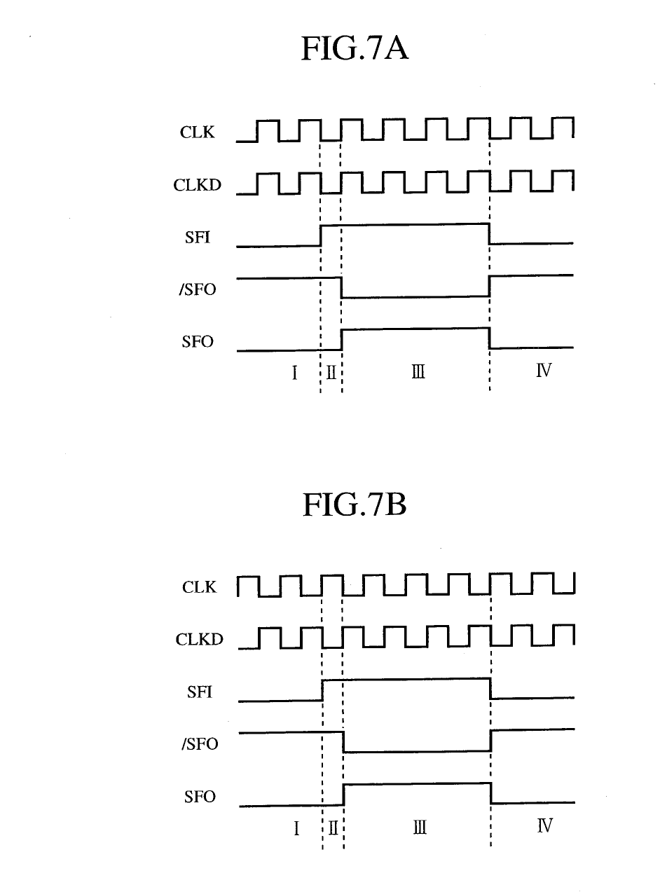

FIGS. 7A and 7B are time charts each illustrating the operation of the generator 29. The operation of the generator 29 varies depending on whether it is in the even-numbered SFFs or odd-numbered SFFs.

FIG. 7A is a time chart illustrating the operation of the even-numbered generator 29. It loads the scan flag input signal SFI in synchronism with the falling edge of the clock signal CLK, and outputs the scan flag output signal SFO in synchronism with the rising edge of the clock signal.

FIG. 7B is a time chart illustrating the operation of the odd-numbered generator 29. It loads the scan flag input signal SFI in synchronism with the rising edge of the clock signal CLK, and outputs the scan flag output signal SFO in synchronism with the falling edge of the clock signal.

The operation of the generator 29 varies as described above when considering it with reference to the clock signal CLK. However, when considering the operation with reference to a clock signal CLKD supplied to the generator 29, the operation is identical in that the generator 29 receives the scan flag input signal SFI in synchronism with the falling edge of the clock signal CLKD, and outputs the scan flag output signal SFO in synchronism with its rising edge. Accordingly, the operation will be described with reference to the clock signal CLKD below.

Phase I

Since the scan flag input signal SFI=LOW, the PMOS 30 is in the ON state, and the NMOS 31 is in the OFF state, thereby placing the scan flag output signal SFO=LOW.

Phase II

The scan flag input signal SFI is input in synchronism with the falling edge of the CLKD so that the scan flag input signal is placed at SFI=HIGH. Thus the PMOS 30 is turned OFF, and the NMOS 31 is turned ON. However, since the NMOS transistors 32 and 33 keep the OFF state, the node /SFO is held at HIGH by a parasitic capacitance C1, thereby maintaining the scan flag output signal SFO at LOW.

Phase III

At the rising edge of the clock CLKD=HIGH, the NMOS 32 is turned ON, thereby discharging the electric charge stored in the parasitic capacitance C1. This brings the node /SFO to LOW and the scan flag output signal SFO to HIGH.

Subsequently, the CLKD becomes LOW again, and the NMOS 32 is turned OFF. However, since the scan flag output signal SFO=HIGH, the NMOS 33is in the normally ON state, thereby maintaining the scan flag output signal SFO at HIGH.

Phase IV

When the scan flag input signal becomes SFI=LOW again, the NMOS 31 is turned OFF, and the scan flag output signal becomes SFO=LOW regardless of the CLKD, returning to the initial state.

As described above, the present embodiment 1 of the test apparatus of a semiconductor integrated circuit carries out the shift-in and shift-out operations of the scan data in synchronism with the different clock edges. Accordingly, it is free from the hold error, thereby obviating the need for inserting buffers on the scan path as the hold error protective measures. Since this principle holds true independently of the evolution of the process, the present embodiment 1 can maintain the number of the gates required for the scan test at a fixed value even if the delay of the transistors reduces in the future. Thus, it can limit the number of gates necessary for the scan test. In addition, since the present embodiment 1 does not require to insert the buffers as the hold error protective measures, it can prevent the design flow from becoming complicated.

Embodiment 2

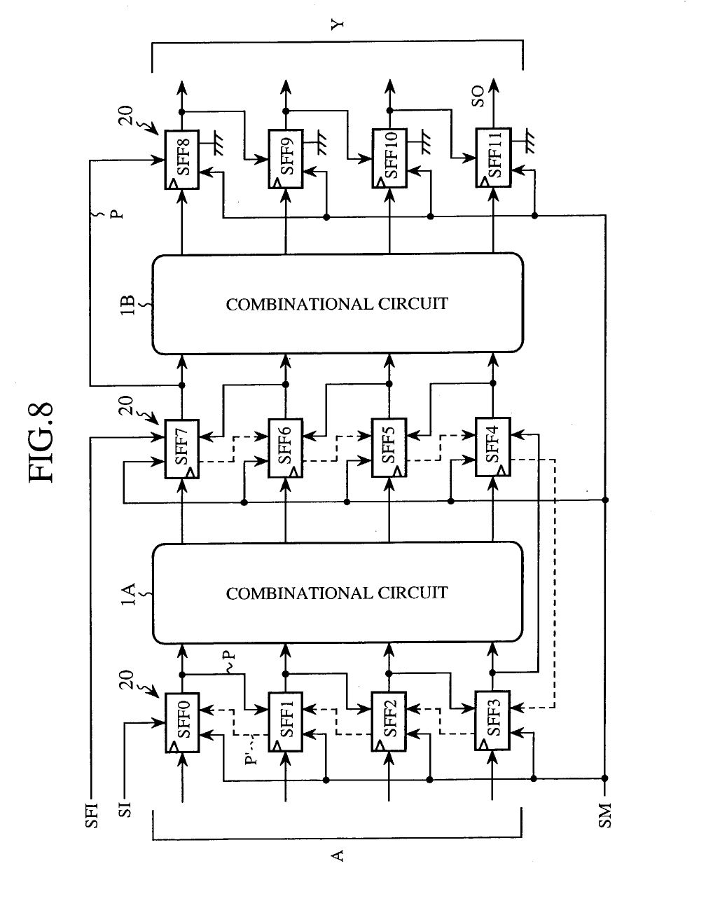

FIG. 8 shows an embodiment 2 of the test apparatus of a semiconductor integrated circuit in accordance with the present invention. The embodiment 2 differs from the foregoing embodiment 1 of FIG. 1 in that it supplies the scan flag input signal SFI fed from the outside to the SFI terminal of the SFF7, and fixes the SFI terminals of the SFF8-SFF11 at LOW. The configuration can facilitate the generation of the scan data because it is enough for the outside to assert the scan flag input signal SFI at the timing when the scan data arrives at the SFF7.

In this way, the transmission of the scan flag can be started from any one of the SFFs, and the SFI terminals of the SFFs used only for the shift-out can be fixed at LOW. In addition, these SFFs can be replaced by the conventional SFFs.

Embodiment 3

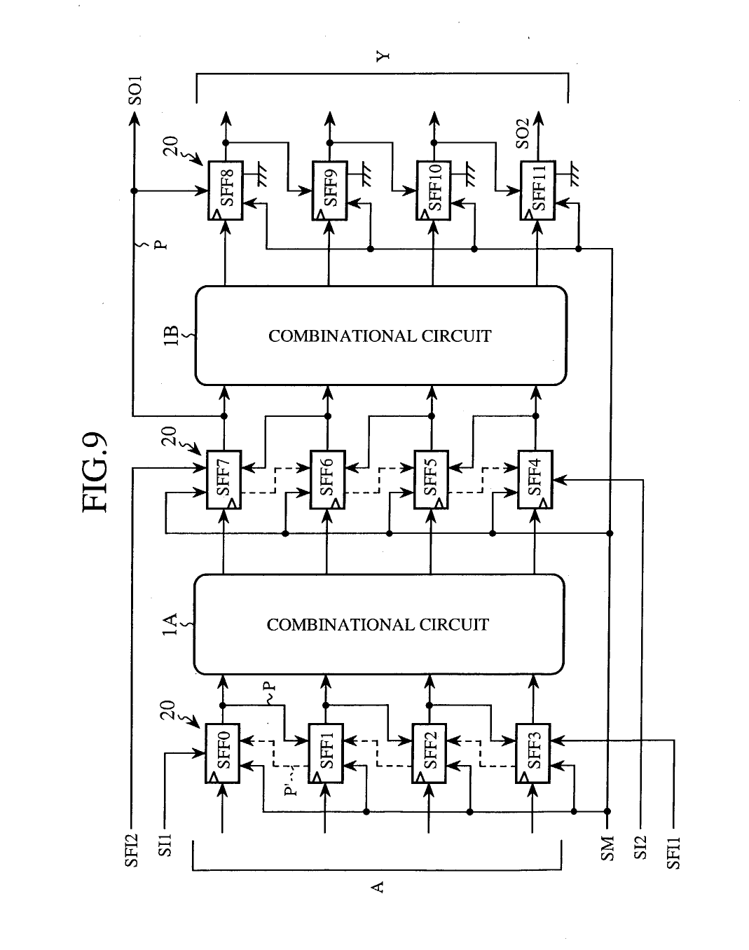

FIG. 9 show an embodiment 3 of the test apparatus of a semiconductor integrated circuit in accordance with the present invention. To reduce the test time, it is possible for the scan design to provide SI1 and SI2 as the SI terminal, SO1 and SO2 as the SO terminal, and SFI1 and SFI2 as the SFI terminal, thereby dividing the scan path to a plurality of scan paths. The present embodiment 3 can cope with the plurality of scan paths by adding the new SI2, SFI1 and SO1 terminals to the configuration as shown in FIG. 8. Incidentally, in some rare cases, a plurality of scan paths have the same scan path depth. In such cases, it is not necessary to provide an additional SFI terminal, but is only necessary to connect the external SFI terminal in common to the SFI terminals of the plurality of SFFs from which the scan flag starts.

Although the configuration of FIG. 9 shows an example with the two scan paths, the present invention is not limited to two scan paths. For example, configurations including three or more scan paths can be implemented in an analogous way.

Embodiment 4

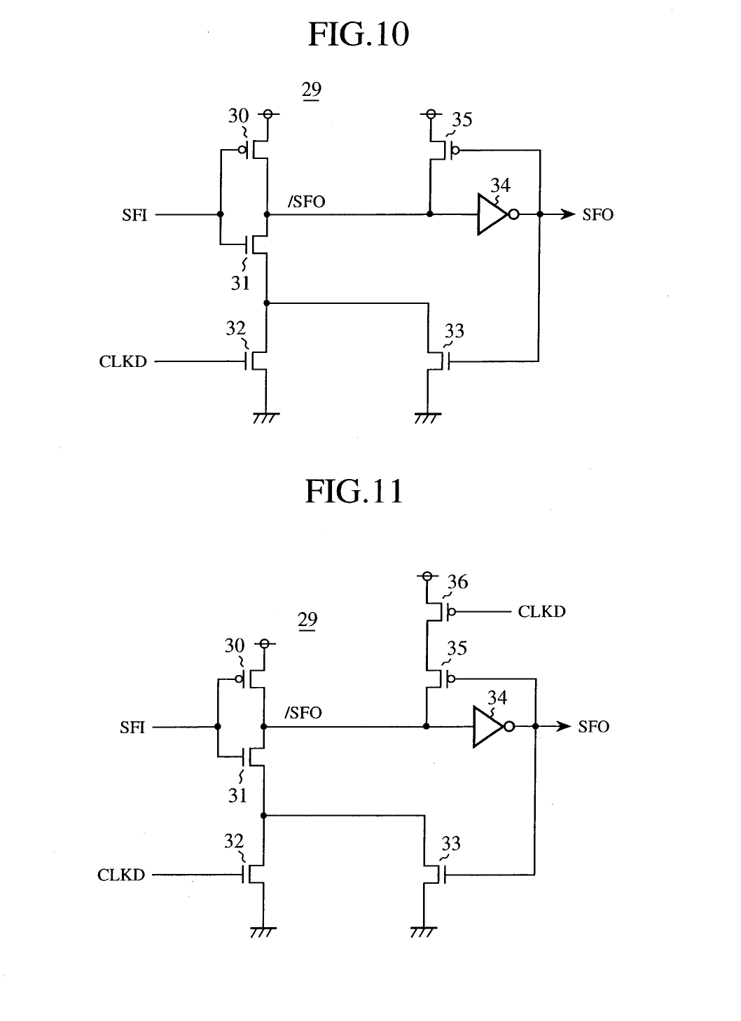

Although the foregoing embodiments 1-3 suppose the generator 29 that holds the voltage level dynamically, another generator 29 that holds the voltage level statically is also possible. FIG. 10 shows such an embodiment 4, which differs from the configuration of FIG. 6 in that it includes an additional high resistance PMOS 35.

The additional PMOS 35 can maintain the node /SFO at HIGH even in the Phase II where the PMOS 30 and NMOS transistors 31 and 32 are in the OFF state. In addition, since the PMOS 35 is a high resistance P-type transistor, when the NMOS 32 is turned on in response to the input of the clock, the node /SFO is pulled down to LOW, and the SFO is turned to HIGH. When the SFO is changed to HIGH, the PMOS 35 is turned off, and the flow-through current from a power supply to the ground is interrupted.

Embodiment 5

FIG. 11 shows the generator 29 of an embodiment 5. In the foregoing embodiment 4 as shown in FIG. 10, the flow-through current flows from the power supply to the ground instantaneously at the level transition of the node /SFO. The present embodiment 5 has a configuration for preventing such a problem.

The present embodiment 5 differs from the embodiment 4 as shown in FIG. 10 in that it includes an additional PMOS 36 connected in series with the PMOS 35 as shown in FIG. 11. Operating the PMOS 36 in response to the clock signal CLK enables the PMOS 36 to turn off at the moment when the clock turns to HIGH, thereby enabling the level transition of the node /SFO without causing the flow-through current to flow.

Although the PMOS 36 is connected closer to the power supply voltage than the PMOS 35 in FIG. 11, it is enough for the PMOS transistors 35 and 36 to be connected in series, and hence either of them may be connected closer to the power supply voltage. In addition, it is not necessary for the PMOS 35 to be a high resistance type transistor.

Embodiment 6

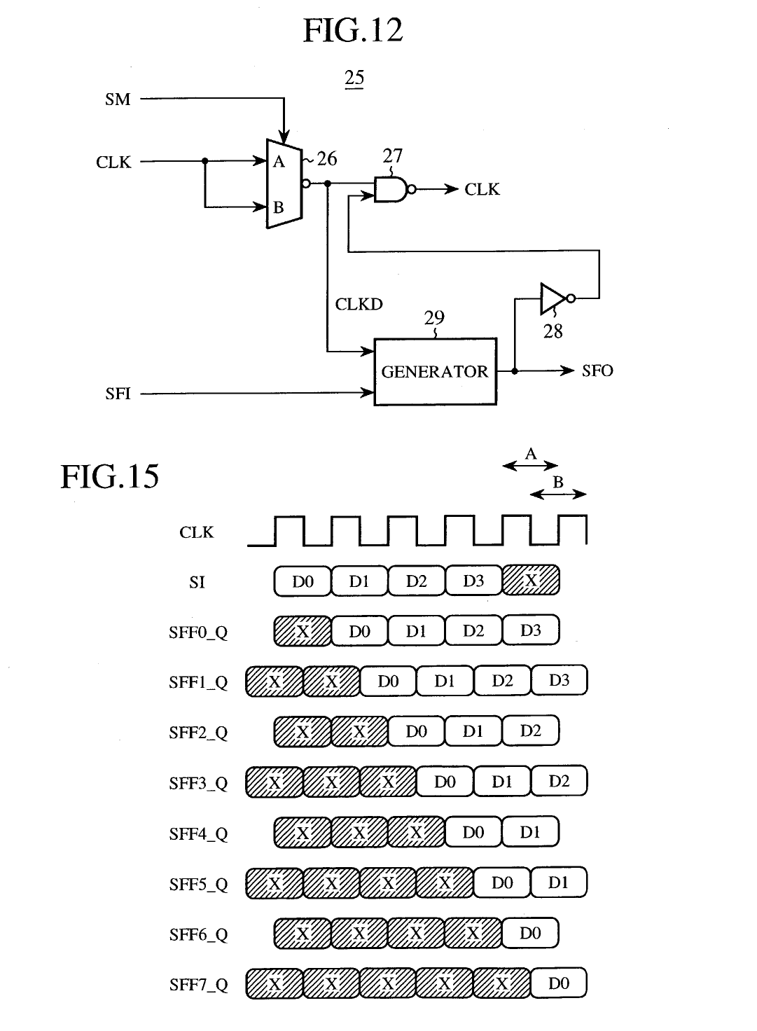

Although the clock generating circuits 25 of the foregoing embodiments halt the clock signal to be supplied to the FFs 23 by the scan flag input signal SFI, it can also hold the clock signal CLK by the scan flag output signal SFO generated by the generator 29. FIG. 12 shows a clock generating circuit 25 with such a configuration. The present embodiment 6 differs from the configuration of FIG. 3A in that its inverter 28 changes its position from the SFI path to the SFO path. Since the basic operation is the same as that of FIG. 3A, the description thereof is omitted here.

Embodiment 7.

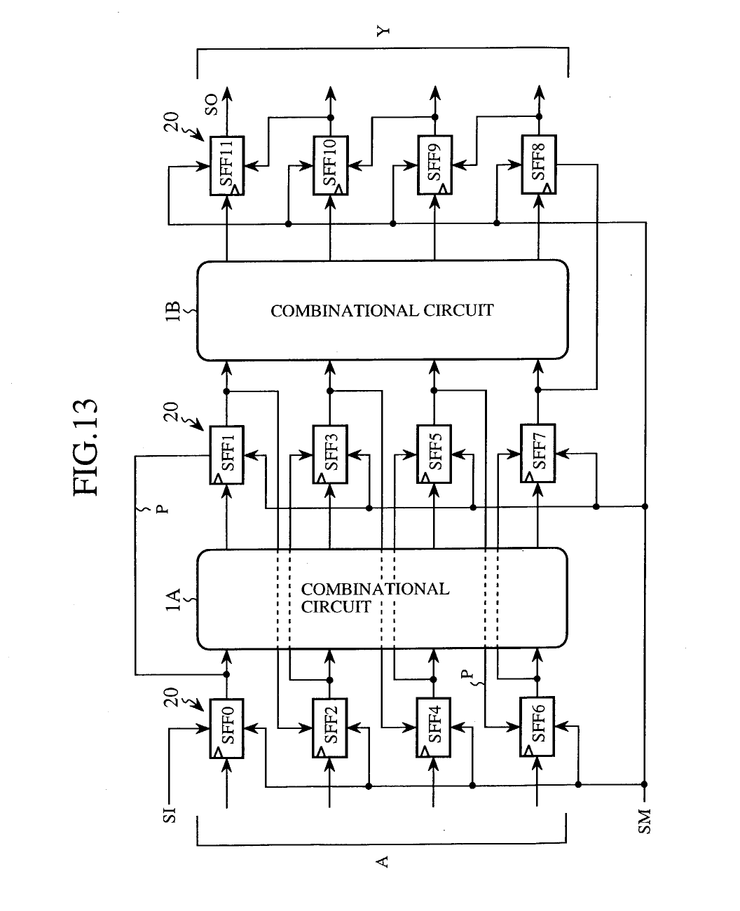

FIG. 13 shows an embodiment 7 of the test apparatus of a semiconductor integrated circuit in accordance with the present invention. It shows another configuration for implementing the shift operation of the scan data in half the clock cycle. The present embodiment 7 differs from the conventional scan test apparatus of FIG. 20 in the following. First, it alters the scan chain sequence for simplifying the description. Second, it has SFFs 20 with a different configuration, and carries out different scan operation as described below.

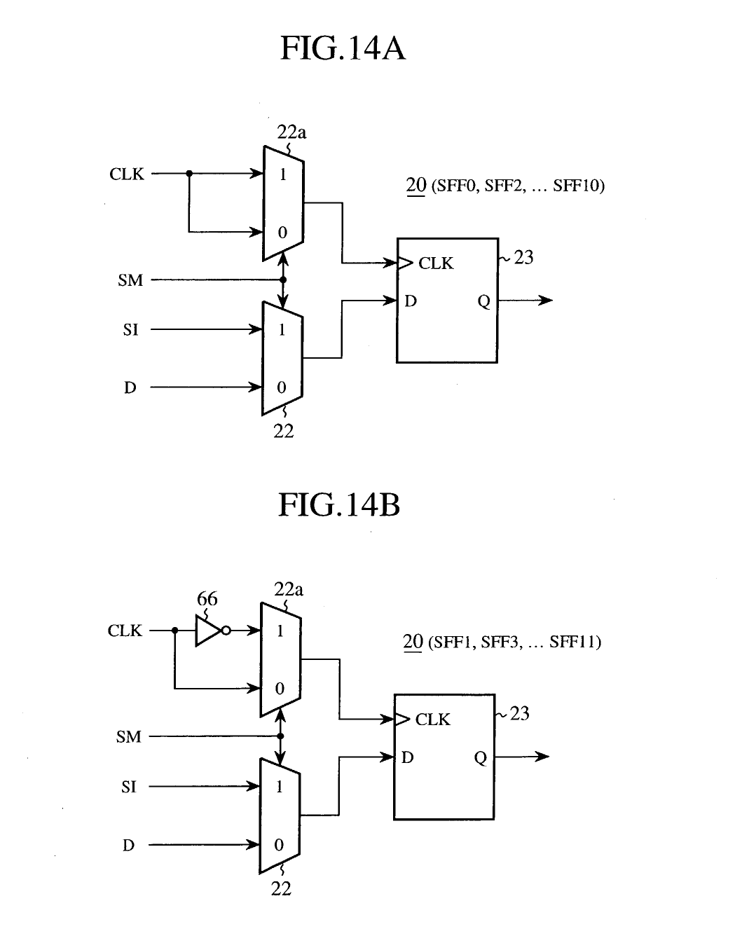

FIGS. 14A and 14B are circuit diagrams each showing a configuration of the SFF 20 of the present embodiment 7. In the present embodiment 7, the even-numbered SFFs and odd-numbered SFFs have different configurations to carry out the data transfer in half the clock cycle.

First, the odd-numbered SFF as shown in FIG. 14B differs from the conventional SFF of FIG. 22 in that it further comprises an inverter 66 and a selector 22a for supplying the FF 23 with the inverted clock signal CLK when SM=1. On the other hand, the even-numbered SFF as shown in FIG. 14A includes the selector 22a for supplying the FF 23 with the non-inverted clock signal CLK even when SM=1.

FIG. 15 is a time chart illustrating the shift-in operation of the present embodiment 7. In the scan test of the present embodiment 7, the even-numbered SFFs prepare the scan data simultaneously, and then the odd-numbered SFFs prepare the scan data simultaneously. Thus, the present embodiment 7 carries out the scan test through two stages. The first stage of the test is carried out by the shift-in operation, run operation, and scan-out operation of the even-numbered or odd-numbered scan data. Subsequently, the second stage of the test is carried out by the shift-in operation, run operation, and scan-out operation of the remaining scan data. In FIG. 15, the data in Phase A are used for the even-numbered SFFs, whereas the data in Phase B are used for odd-numbered SFFs.

The two stage test of the present embodiment 7 can be completed without any problem just as the test can be performed when the scan path is divided into a plurality of paths.

Embodiment 8.

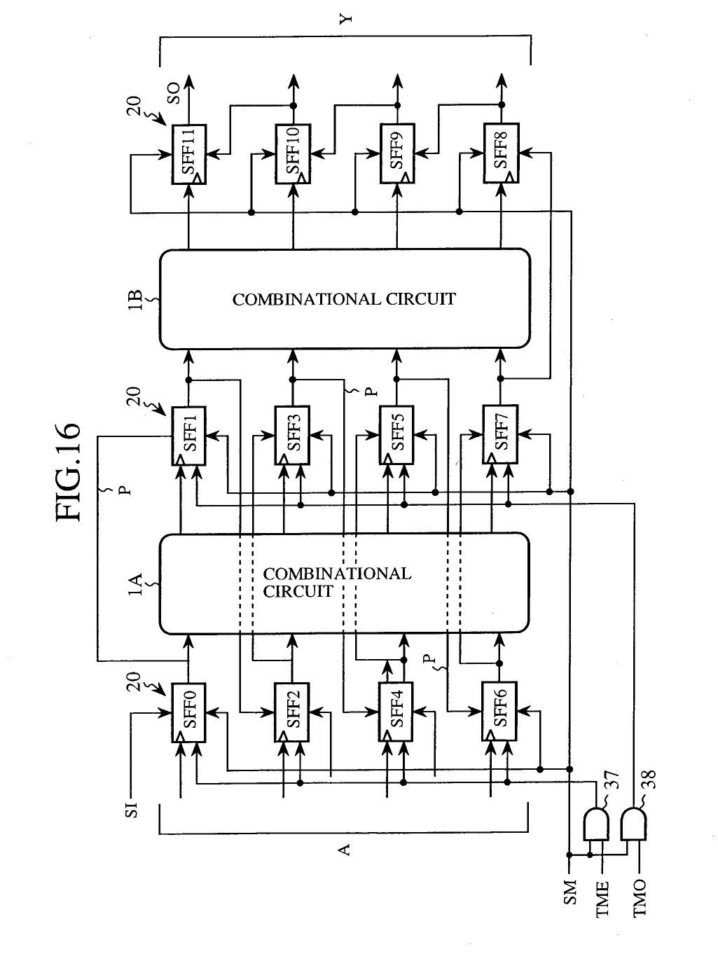

Although the foregoing embodiments describe the scan test that carry out the shift operation in half the clock cycle, the test apparatus in accordance with the present invention can also be implemented using the clock signals with the same phase. FIG. 16 shows such a configuration which comprises AND circuits 37 and 38 in addition to the conventional scan test circuit as shown in FIG. 20. The AND circuit 37 ANDs a through mode even signal TME and the scan mode signal SM, and the AND circuit 38 ANDs a through mode odd signal TMO and a scan mode signal SM. In addition, the circuit of FIG. 16 alters the sequence of the scan path from that of the circuit of FIG. 20 for simplifying the description.

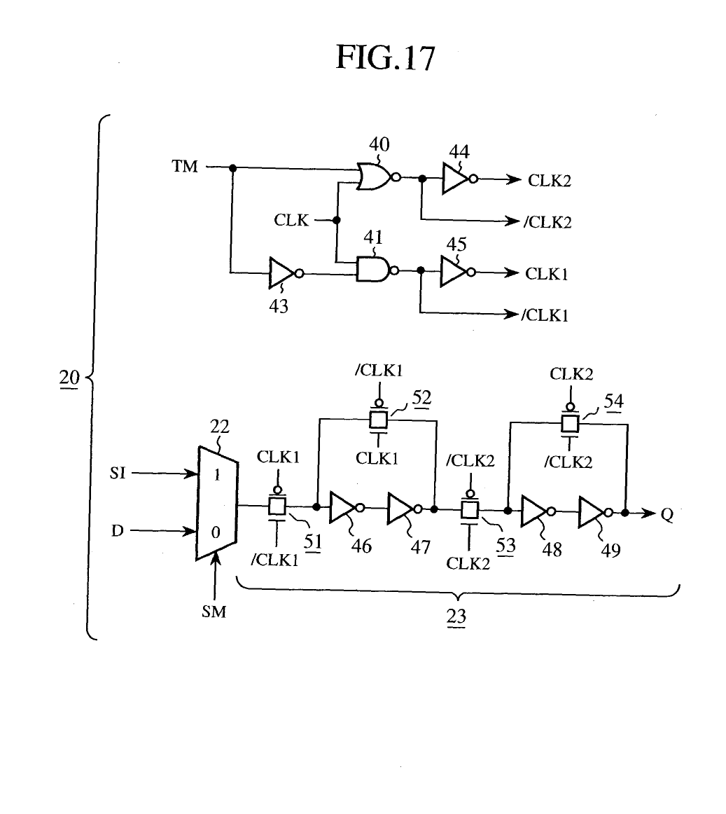

FIG. 17 shows a configuration of the SFF 20 of the present embodiment 8. In FIG. 17, the reference numeral 40 designates a NOR circuit, 41 designates a NAND circuit, reference numerals 43-49 each designate an inverter, and 51-54 each designate a transmission gate. The output terminals of the NOR circuit 40, NAND circuit 41 and inverters 44 and 45 are connected to the control terminals of the transmission gates 51-54 denoted by the corresponding symbols /CLK2, /CLK1, CLK2, and CLK1, respectively. The remaining inverters 46-49 have a buffer function.

In the SFF 20, when a through mode signal TM from the outside is TM=1, it fixes the clock signals at CLK1=0 and CLK2=1. Thus, when the through mode signal is input, both the master latch and slave latch of the FF 23 become the through mode. Returning to FIG. 16, the output of the AND circuit 37 ANDing the through mode even signal TME and the scan mode signal SM is connected to the TM terminal of the even-numbered SFFs, and the output of the AND circuit 38 ANDing the through mode odd signal TMO and the scan mode signal SM is connected to the TM terminal of the odd-numbered SFFs.

The entire operation of the present embodiment 8 using the SFFs 20 is as follows. The present embodiment 8 also carries out the scan test through the two stages. First, to shift the data into the even-numbered SFFs, the through mode even signal TME is placed at TME=0 and the through mode odd signal TMO is placed at TMO=1 to perform the shift-in operation of the scan data. In this case, since all the odd-numbered SFFs become the through mode, the shift-in operation to only the even-numbered SFFs is carried out. When the shift-in operation has been completed, the run operation is carried out, and the outputs of the combinational circuit 1A are stored in the odd-numbered SFFs, SFF1, SFF3, SFF5 and SFF7. Subsequently, placing the SM=1 again and carrying out the shift-out operation can shift the data to the output side SFFs, SFF8-SFF11.

On the other hand, to test the combinational circuit 1B by carrying out the shift-in operation of the data to the odd-numbered SFFs, the through mode even signal TME is placed at TME=1, and the through mode odd signal TMO is placed at TMO=0, followed by the test in the same manner.

As described above, although the present embodiment 8 carries out the scan operation using the same clock edge, it can reduce the hold error because of the through state FFs 23 on the scan path P.

Embodiment 9

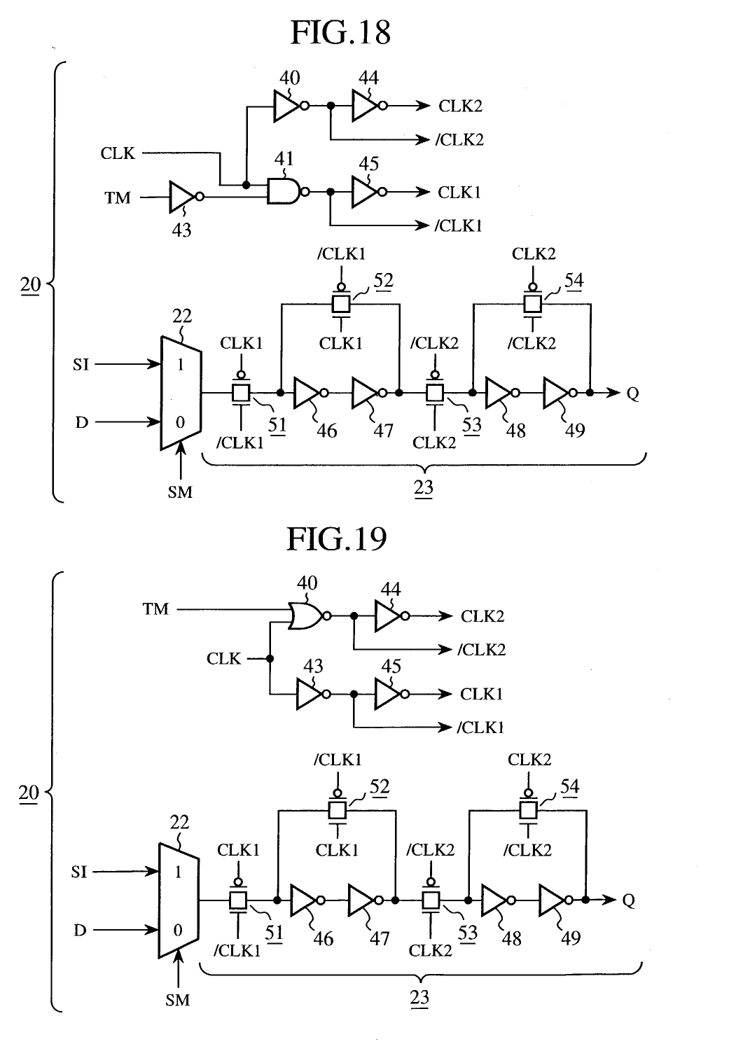

FIG. 18 shows another configuration of the SFF 20 of an embodiment 9 which can implement the functions as those of the foregoing embodiment 8 by setting one of the latches of the FF 23, the master latch or slave latch, at the through mode.

In FIG. 18, when the through mode signal TM=1, only the master latch becomes the through mode. On the other hand, the slave latch becomes the through mode during the time period in which the clock signal CLK=1. Since the master latch is forced to become the through mode by the AND operation, the FF 23 becomes the through mode in the time period, thereby offering the same advantages as the configuration of FIG. 17 with a smaller number of components.

Embodiment 10

By forcedly placing the slave latch at the through mode, the same advantages can be achieved by a smaller number of components. FIG. 19 shows such an embodiment 10.

In FIG. 19, when the clock becomes 1, the master latch also becomes the latch mode. Accordingly, it is likely that the hold error occurs between the previous FF 23 and the master latch. However, since the FF 23 to which the data is to be shifted is placed at the next stage in practice, it is necessary for the data to pass through the slave latch in the through mode to cause the hold error. This is equivalent to that the entire FF becomes the through mode. Consequently, the present embodiment 10 can offer the same advantages as those of the foregoing embodiments 8 and 9.

What is claimed is:

1. A test apparatus of a semiconductor integrated circuit having a scan path that includes even-numbered scan flip-flops and odd-numbered scan flip-flops adjacent to one another, and that transfers scan data, wherein
each of said even-numbered scan flip-flops comprises a flip-flop for shifting scan data at a first level transition of a clock signal in a test scan mode, and a clock control circuit for outputting and halting the clock signal; and
each of said odd-numbered scan flip-flops comprises a flip-flop for shifting scan data at a second transition of a clock signal opposite to the first transition in a shift direction in the test scan mode, and a clock control circuit for outputting and halting the clock signal.

2. The test apparatus of a semiconductor integrated circuit according to claim 1, wherein each of said clock control circuits comprises means for halting the clock signal in response to an input scan flag; and a scan flag generator for generating an output scan flag by delaying the input scan flag by half a clock cycle and for supplying the output scan flag to the adjacent scan flip-flop as its input scan flag, and wherein each of said clock control circuits of said odd-numbered scan flip-flops further comprises means for inverting the clock signal in the test scan mode.

3. The test apparatus of a semiconductor integrated circuit according to claim 2, wherein said scan flag generator comprises a series circuit of a first PMOS transistor and a first NMOS transistor having their gates supplied with the input scan flag; an inverter having its input terminal connected to drains of said first PMOS transistor and said first NMOS transistor and producing an output scan flag from its output terminal; a second NMOS transistor connected in series to the series circuit and having its gate supplied with the clock signal; and a third NMOS transistor connected in parallel with the second NMOS transistor and having its gate connected to the output terminal of said inverter.

4. The test apparatus of a semiconductor integrated circuit according to claim 3, wherein said scan flag generator further comprises a second PMOS transistor having its drain connected to the input terminal of said inverter and its gate connected to the output terminal of said inverter.

5. The test apparatus of a semiconductor integrated circuit according to claim 4, wherein said scan flag generator further comprises a third PMOS transistor connected in series with said second PMOS transistor and having its gate supplied with the clock signal.

6. The test apparatus of a semiconductor integrated circuit according to claim 1, wherein said even-numbered scan flip-flops and said odd-numbered flip-flops carry out the scan test separately.

7. A test apparatus of a semiconductor integrated circuit comprising:
a scan path that includes even-numbered scan flip-flops and odd-numbered scan flip-flops adjacent to one another, and that transfers scan data; and
switching means for switching between a scan test of said even-numbered scan flip-flops and a scan test of said odd-numbered flip-flops.

8. The test apparatus of a semiconductor integrated circuit according to claim 7, wherein each of said scan flip-flops comprises means for halting the clock signal in response to an external scan mode signal.

9. The test apparatus of a semiconductor integrated circuit according to claim 7, wherein said switching means comprises a first AND circuit for ANDing an even-number through mode signal and a scan mode signal, and a second AND circuit for ANDing an odd-number through mode signal and the scan mode signal, and means for placing desired scan flip-flops on the scan path at a through mode in response to outputs of said first AND circuit and of said second AND circuit.

10. The test apparatus of a semiconductor integrated circuit according to claim 9, wherein said means for placing sets at least one of a master latch and a slave latch constituting each of the scan flip-flops at the through mode.
